(19) United States
(12) Patent Application Publication
(10) Pub. No.: US 2014/0172509 A1
(43) Pub. Date: Jun. 19, 2014

(54) SALES MANAGEMENT APPARATUS AND COMPUTER-READABLE STORAGE MEDIUM

(71) Applicant: Casio Computer Co., Ltd., Tokyo (JP)

(72) Inventor: Mitsuharu KAMIYA, Tokyo (JP)

(73) Assignee: CASIO COMPUTER CO., LTD., Tokyo (JP)

(21) Appl. No.: 14/096,429

(22) Filed: Dec. 4, 2013

(30) Foreign Application Priority Data
Dec. 14, 2012 (JP) 2012-272996

(51) Int. Cl. G06Q 30/02

(52) U.S. Cl. CPC G06Q 30/0205
USPC 705/7.34

(57) ABSTRACT

An sales management apparatus of the present invention for managing sales data transmitted from a sales terminal device via a communication network includes a receiving section which receives sales data and position data of a sales venue transmitted from the sales terminal device placed on a mobile sales vehicle side when sales are being conducted at the sales venue by the mobile sales vehicle, a totalizing section which totalizes the sales data by mobile sales for each sales venue based on the sales data and the position data received by the receiving section, an analyzing section which analyzes the totalization results obtained by the totalizing section according to an analysis condition for analyzing the totalization results obtained by the totalizing section, and an output section which develops and outputs the analysis results obtained by the analyzing section on a map.

### CROSS-REFERENCE TO RELATED APPLICATION

This application is based upon and claims the benefit of priority from the prior Japanese Patent Application No. 2012-272996, filed Dec. 14, 2012, the entire contents of which are incorporated herein by reference.

### BACKGROUND OF THE INVENTION

1. Field of the Invention

The present invention relates to a sales management apparatus that manages sales data transmitted via a communication network from a sales terminal device, and a computer-readable storage medium.

2. Description of the Related Art

In recent years, mobile sales where products are sold by using vehicles attract attention mainly from youths, women, and senior citizens. One reason for this is that operating hours and an operation venue can be freely determined. For operation of mobile sales, operating permission by the public health center based on the food sanitation law and road use permission by the police office based on the road traffic law are required. Unauthorized sales on the road are subjected to administrative disposition or criminal penalty.

Although parks are not a road and therefore are not under control of the road traffic law, parks are under control of laws regarding the use of parks. To open a shop there, permission by a municipality is required and, in principal, the use for commercial purposes is not allowed. Moreover, with regard to commercial advertising of mobile sales with the use of a loudspeaker, the sound volume and use are controlled under regulations by administrative divisions.

Conventionally, as a technology regarding mobile sales vehicles, a technology has been proposed in which the sales venue and travelling course of a mobile sales vehicle, sales products, and prices are searchable and viewable from portable phones and personal computers, a mail guide is sent, and advance reservations can be made (for example, refer to Japanese Patent Application Laid-Open (Kokai) Publication No. 2011-221984).

As such, conventional services for users using mobile sales are mostly systems allowing a search for sales venues and production information, and mail guide notifications.

Meanwhile, although no law regulates mobile sales on private lands such as parking lots, shopping malls, and vacant lots, permission from their landowner or manager is required. As mobile sales have become socially acknowledged, legal sales methods on private lands are indispensable to establish credibility.

Under these circumstances, although sites for matching mobile sales vehicle with event organizers at commercial facilities are present in some network services, it is very difficult for mobile sellers to constantly secure an operation venue due to problems of operating days and competition in estimates.

Moreover, in a case where a commercial facility or a parking lot is rented to a mobile seller, credibility and contract procedures are required, and the term of contract is long. Therefore, it is difficult for mobile sellers, who are mostly private enterprises and microenterprises, to rent such a venue.

Accordingly, the applicant has suggested a technology by which a sales venue can be easily provided to a mobile sales vehicle, and whether mobile sales are being conducted at an appropriate venue can be easily confirmed. That is, the applicant has suggested a wide-area communication system which provides services usable by the hour by mobile sellers (mobile sales vehicles) anytime as required, for the purpose of effectively using pay-by-the-hour parking lots (private lands) already operated in urban areas nationwide. To further enrich and develop this wide-area net services, it is required to provide mobile sellers with information contributing to high sales efficiency.

### SUMMARY OF THE INVENTION

The present invention is to help mobile sellers (mobile sales vehicles) find sales venues and plainly provide information contributing to high sales efficiency.

In accordance with one aspect of the present invention, there is provided a sales management apparatus which manages sales data transmitted from a sales terminal device via a communication network, comprising: a receiving section which receives sales data and position data of a sales venue transmitted from the sales terminal device placed on a mobile sales vehicle side, when sales are being conducted at the sales venue by the mobile sales vehicle; a totalizing section which totalizes the sales data by mobile sales for each sales venue based on the sales data and the position data received by the receiving section; an analyzing section which, when an analysis condition for analyzing totalization results obtained by the totalizing section is specified, analyzes the totalization results obtained by the totalizing section according to the analysis condition; and an output section which develops and outputs analysis results obtained by the analyzing section on a map.

In accordance with another aspect of the present invention, there is provided a non-transitory computer-readable storage medium having stored thereon a program that is executable by a computer, the program being executable by the computer to perform functions comprising: processing for receiving, via a communication network, sales data and position data of a sales venue transmitted from a sales terminal device placed on a mobile sales vehicle side when sales are being conducted at the sales venue by the mobile sales vehicle; processing for totalizing the sales data by mobile sales for each sales venue based on the received sales data and position data; processing for analyzing totalization results according to an analysis condition for analyzing the totalization results; and processing for developing and outputting analysis results on a map.

According to the present invention, it is possible to help mobile sellers (mobile sales vehicles) find sales venues and plainly provide information contributing to high sales efficiency, whereby mobile sales can be promoted and the effective use of sales venues can be expected.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is a block diagram outlining the entire structure of a sales data processing system;

FIG. 2 is a block diagram depicting basic components of a management server apparatus (sales management apparatus) 1;

FIG. 3 is a block diagram depicting basic components of a sales terminal device 2;

FIG. 4 is a diagram for describing a parking lot information database SD1 on the management server apparatus 1 side;

FIG. 5 is a diagram for describing a selling management information database SD2 on the management server apparatus 1 side;

FIG. 6 is a diagram for describing a sales management information database SD3 on the management server apparatus 1 side;

FIG. 7A and FIG. 7B are diagrams for describing an operation guide information database SD4 on the management server apparatus 1 side;

FIG. 8 is a diagram for describing an area analysis information database SD5 on the management server apparatus 1 side;

FIG. 9 is a flowchart outlining the operation of a characteristic portion of the present embodiment from among all of the operations of the management server apparatus 1;

FIG. 10 is a flowchart of an operation following the operation of FIG. 9;

FIG. 11 is a flowchart of an operation following the operation of FIG. 10;

FIG. 12A and FIG. 12B are diagrams exemplarily depicting area analysis condition input sheets of different types;

FIG. 13 is a diagram exemplarily depicting results (screen data) of area analysis by parking lot developed in a map of a specified area; and

FIG. 14 is a diagram exemplarily depicting results (screen data) of area analysis by area mesh developed in a map of a specified area.

### DETAILED DESCRIPTION OF THE PREFERRED EMBODIMENTS

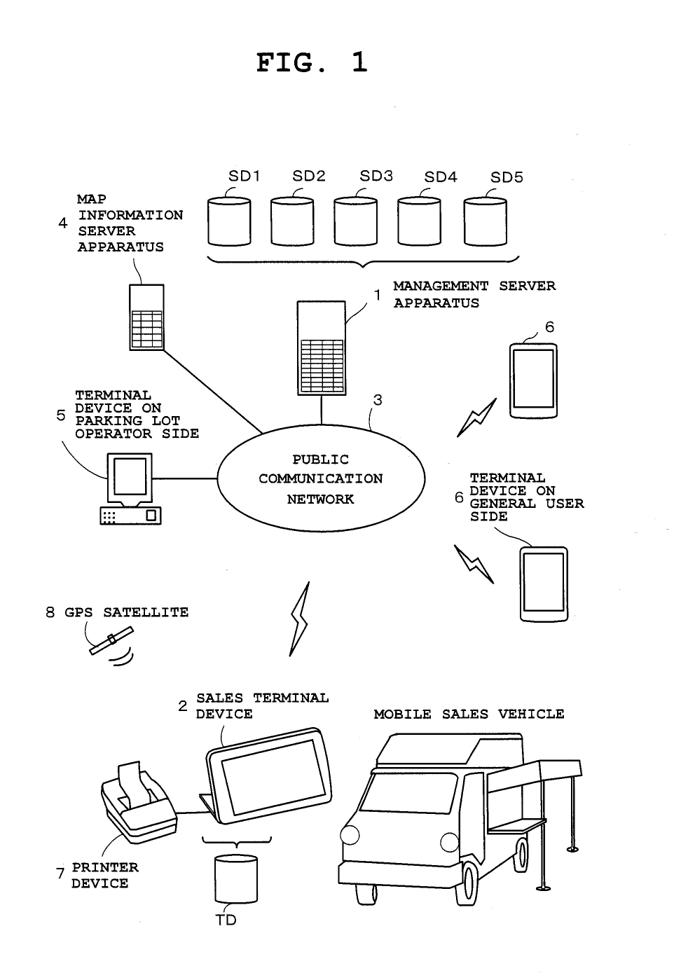

An embodiment of the present invention is described below with reference to FIG. 1 to FIG. 14.

FIG. 1 is a block diagram outlining the entire structure of a sales data processing system.

The sales data processing system is a wide-area communication system which provides services usable by the hour by mobile sellers (mobile sales vehicles) anytime as required, for the purpose of effectively using, as sales venues, pay-by-the-hour parking lots (private lands) already operated in urban areas nationwide.

That is, the sales data processing system is a wide-area communication system which sets up a wide-area network service (a site for mobile sales using parking lots) for providing mobile sellers with parking areas (sales venues) where mobile sales are permitted under contracts with parking lot operators operating business of renting parking lots by the hour, as well as collecting use fees billed with the use of the parking areas from the mobile sellers and paying the fees to the parking lot operators.

The sales data processing system includes a management server apparatus (sales management apparatus) 1 and a sales terminal device 2 set on a mobile sales vehicle side. This management server apparatus (sales management apparatus) land the sales terminal device 2 are connected to each other via a public communication network (for example, a wireless communication network or the Internet) 3.

The management server apparatus 1 is a server apparatus set on a site operation business operator side operating a mobile sales site using a parking lot, and is connected to the sales terminal device 2 on the mobile sales vehicle side and to a map information server apparatus 4 via the public communication network 3.

Also, the management server apparatus 1 is connected to a terminal device (such as a portable terminal device or a personal computer) 5 on a parking lot operator side and to a terminal device (such as a portable terminal device or a personal computer) 6 on a general user side via the public communication network 3.

The management server apparatus 1 side includes various databases, such as a parking lot information database SD1, a selling management information database SD2, a sales management information database SD3, an operation guide information database SD4, and an area analysis information database SD5.

The parking lot information database SD1 is a database that stores and manages position data and the like for each parking area (each parking lot) where mobile sales by mobile sales vehicles are permitted under contracts with parking lot operators operating business of renting the parking lots by the hour.

The sales terminal device 2 is a portable information terminal device whose housing is of A5 size as a whole, which is installed (mounted) inside a mobile sales vehicle. This sales terminal device 2 is a sales data processing device having a touch input function and a wireless communication function, as well as an ECR (Electronic Cash Register) function for registering sales data for each transaction and performing cutoff processing at the time of ending registration of one transaction.

Also, the sales terminal device 2 has, in addition to the above-described basic functions (the touch input function, the wireless communication function, and the ECR function), an Internet connection function (a Web access function) and a GPS (Global Positioning System) function.

The sales terminal device 2 includes a sales management information database TD. This database TD has a sales file (omitted in the drawing) for storing inputted sales data (product name, unit price, the number of products, and sales amount) and position data and the like received and obtained from the GPS function every time sales data for one transaction is registered in association with each other.

The sales terminal device 2 further has a printer device 7 connected thereto by a cable for printing and issuing a receipt or a journal.

The GPS function is a function for receiving and obtaining position data regarding the current position of the sales terminal device 2 via a communication with a GPS satellite 8.

In the above-structured sales data processing system, when receiving current position data and the like together with sales data via the public communication network 3 as a sales report of mobile sales from the sales terminal device 2 installed on the mobile sales vehicle side, the management server device 1 searches the parking lot information database SD1 based on the position data so as to specify a parking area relevant to the position data, and processes the received sales data as sales data of sales in the parking area.

In this case, a parking fee according to the time of using the parking area and a compensation for sales according to the sales data are calculated to find a mobile sales use fee, and the mobile sales use fee is transmitted to a terminal device 5 on a parking lot operator side, whereby a payment report is made.

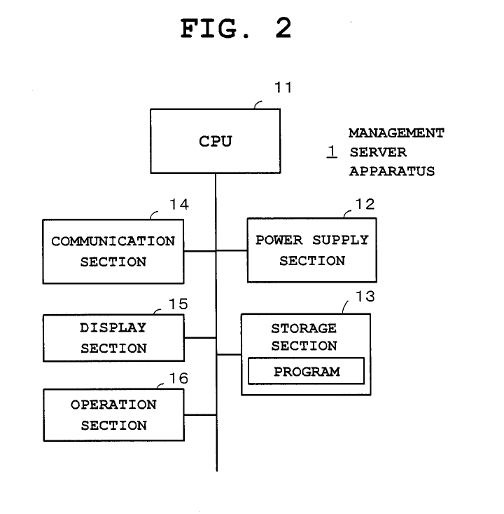

FIG. 2 is a block diagram depicting basic components of the management server apparatus (sales management apparatus) 1.

A CPU (Central Processing Unit) 11 in FIG. 2, which serves as the core of the management server device 1, operates by receiving power from a power supply section 12 including an Uninterruptible Power Supply device (UPS) (omitted in the drawings), and controls the entire operation of the management server device 1 in accordance with various programs in a storage section 13.

The storage section 13 stores various programs and information, such as programs and various applications for actualizing the present embodiment, and has a work area for temporarily storing various information (such as a current time clocked by a clock function, a flag, and a timer) required to operate the management server device 1.

Note that the storage section 13 may include a storage area on a predetermined external server side.

A communication section 14 is capable of performing multiple simultaneous access. This communication section 14 is connected to broadband Internet (such as by optical communication connection), and transmits and receives data to and from the sales terminal device 2, the cartographic information server device 4, the terminal device 5 on the parking lot operator side, and the terminal device 6 on the general user side.

The CPU 11 can also perform processing in accordance with an external instruction received via the communication section 14.

A display section 15 displays an operator confirmation screen, a work screen, etc.

An operation section 16 includes a full keyboard and the like, and the CPU 11 performs processing based on input signals from this operation section 16.

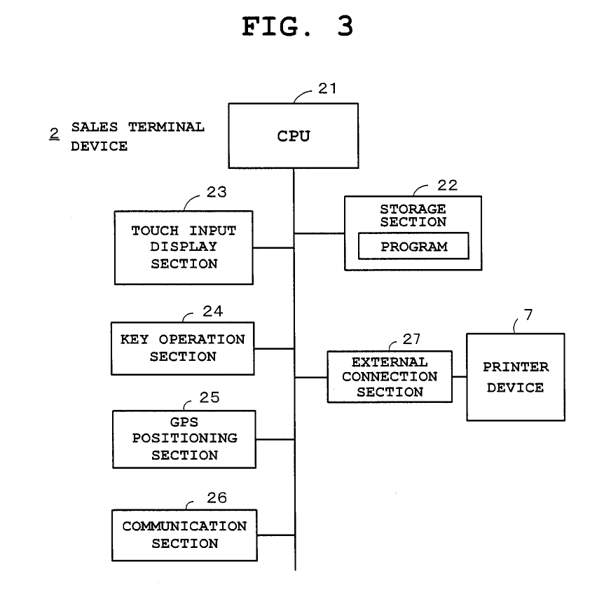

FIG. 3 is a block diagram depicting basic components of the sales terminal device 2.

A CPU 21 in FIG. 3, which serves as the core of the sales terminal device 2, controls the entire operation of the sales terminal device 2 in accordance with various programs in a storage section 22.

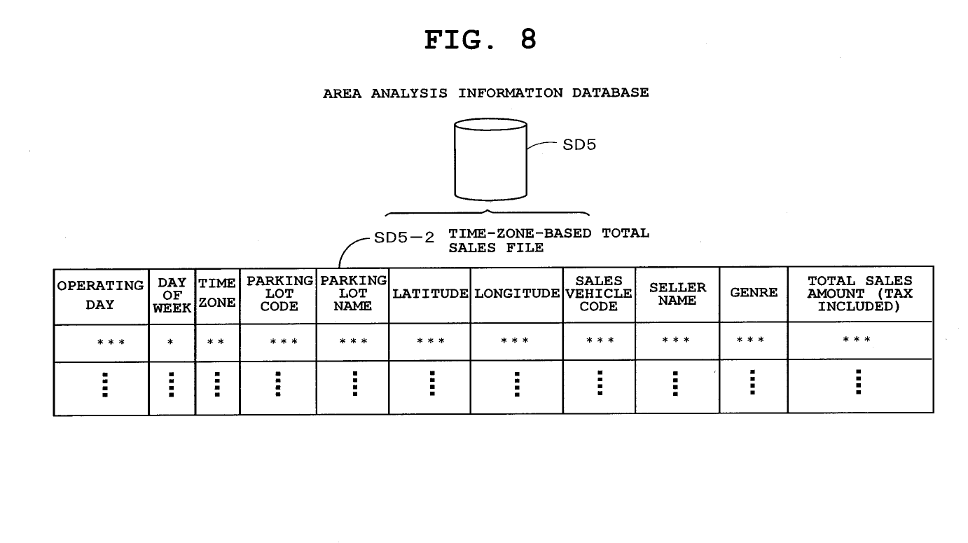

The storage section 22 stores various programs and information, such as programs and various applications for actualizing the present embodiment based on operation procedures depicted in FIG. 8, and has a work area for temporarily storing various information (such as a current time clocked by a clock function, a flag, and a timer) required to operate the sales terminal device 2.

To the CPU 21, a touch input display section 23 and a key operation section 24 are connected as input/output peripheral devices. Also connected are a GPS positioning section 25, a communication section 26, an external connection section 27, and others. The CPU 21 controls operations of these sections in accordance with an input/output program.

The touch input display section 23 is structured to include a display panel and a touch panel (omitted in the drawings). By the touch panel being arranged on the front surface of a high definition display panel, software keys (touch keys) are allocated and arranged. This touch input display section 23 displays function names, or senses a touch operation performed by a finger or the like and inputs data based on the touch operation.

The GPS positioning section 25 constitutes the GPS function described above, and receives and obtains current position data (longitude and latitude data) by using a control station of a ground system/satellite system.

The communication section 26 is a communication interface for transmitting and receiving data to and from the management server device 1 via the public communication network 3. The external connection section 27 is a connector section to which the printer device 7 is connected by a cable.

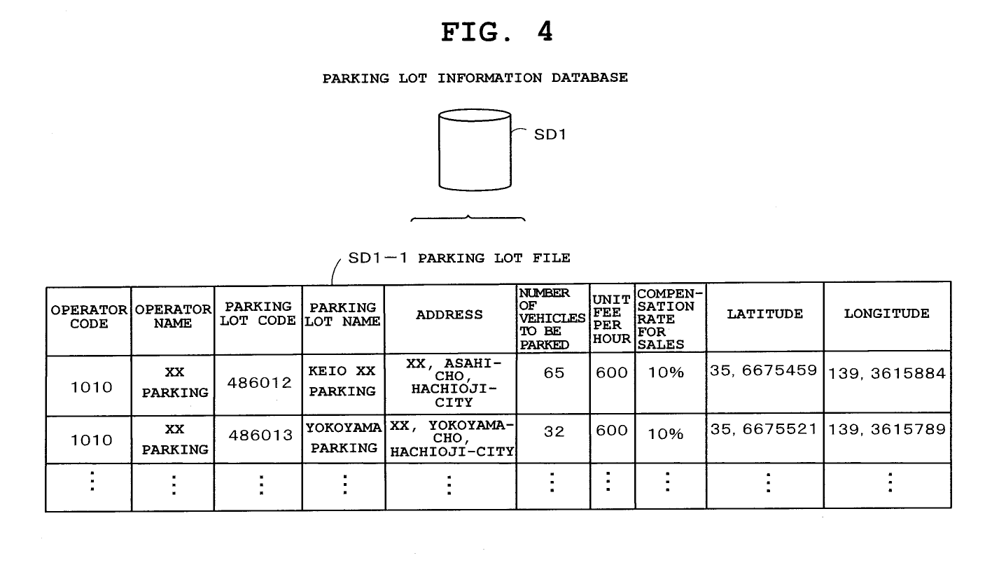

FIG. 4 is a diagram for describing the parking lot information database SD1 on the management server apparatus 1 side.

The parking lot information database SD1 stores and manages data regarding parking lot operators managing parking lot as sales venues, and has a parking lot file SD1-1.

The parking lot file SD1-1 is a file storing registered data by receiving inputs of items described in registration applications submitted from the parking lot operators, and has items of “operator code” and “operator name” as data regarding the parking lot operators and items of “parking lot code”, “parking lot name”, “address”, “number of vehicles to be parked”, “unit fee per hour”, “compensation rate for sales”, “latitude”, and “longitude” as data regarding the parking lots (parking areas) operated by the operators.

“Unit fee per hour” indicates a pay-by-the-hour fee in the parking area (for example, two hundred yen for thirty minutes). “Compensation rate for sales” indicates a compensation rate to be billed by quantity according to a sales amount of movable sales (for example, 10% of the sales amount). “Latitude” and “longitude” are position data corresponding to “address” of the parking lot which have been received and obtained from the cartographic information server device 4.

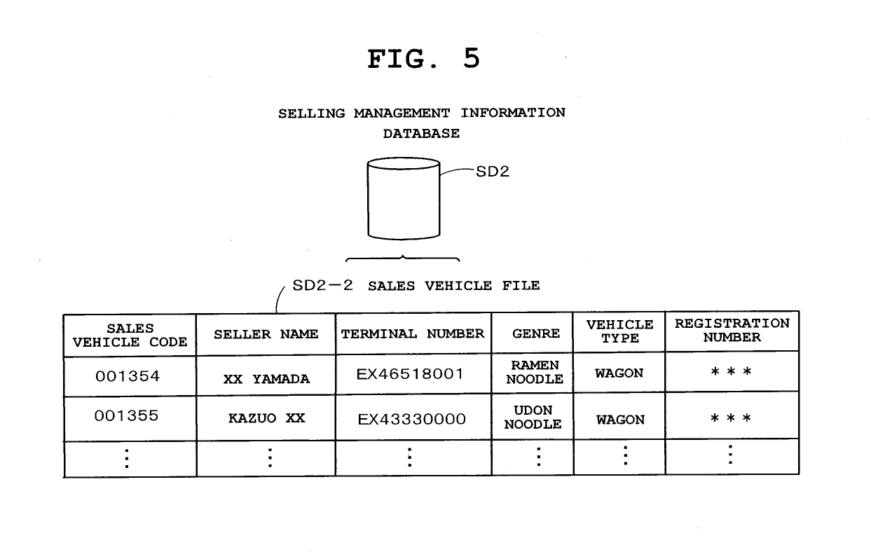

FIG. 5 is a diagram for describing the selling management information database SD2 in the management server device 1.

The selling management information database SD2 stores and manages data regarding mobile sellers (mobile sales vehicles), and has a sales vehicle file SD2-1.

The sales vehicle file SD2-1 is a file storing registered data by receiving inputs of items described in registration applications submitted from the mobile sellers, and has items of “sales vehicle code”, “seller name”, “terminal number”, “genre”, “vehicle type”, and “registration number” as data regarding the mobile sellers (mobile sales vehicles).

“Terminal number” is identification data (for example, a product serial number) of the sales terminal device 2 installed on each mobile sales vehicle. “Genre” indicates the type of a product for sale (for example, ramen, udon, etc.). “Vehicle type” and “registration number” are identification data identifying each mobile sales vehicle.

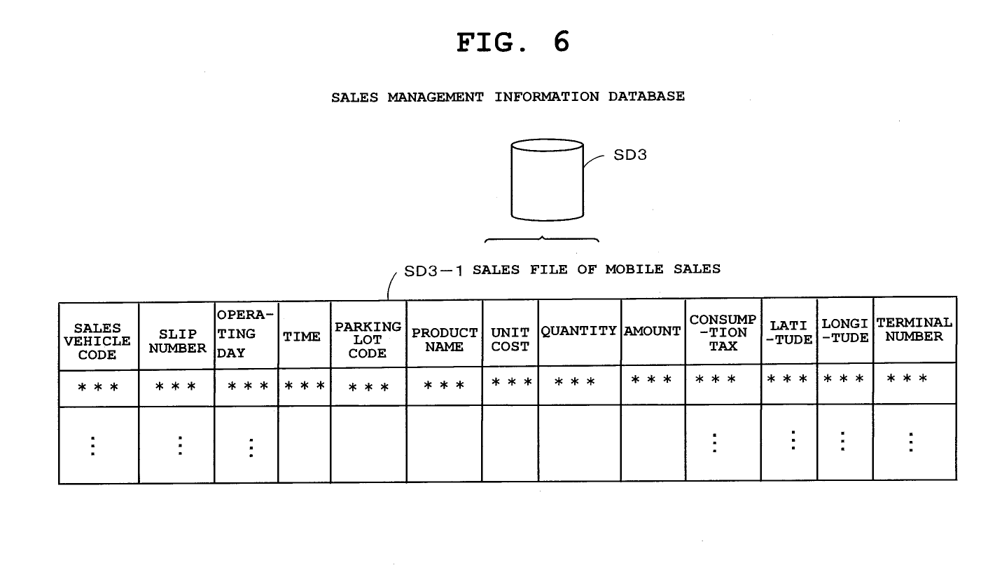

FIG. 6 is a diagram for describing the sales management information database SD3 in the management server device 1.

The sales management information database SD3 stores and manages sales data for each mobile sales vehicle, and has a sales file SD3-1 of mobile sales.

The sales file SD3-1 is a file storing data according to the contents of a sales report of mobile sales received from the sales terminal device 2, and has items of “sales vehicle code”, “slip number”, “operating day”, “time” “parking lot code”, “product name”, “unit cost”, “quantity”, “amount”, and “consumption tax” as sales data for each mobile sales vehicle and items of “latitude” and “longitude” as data regarding the parking areas used for mobile sales.

“Slip number” is a serial number issued for each transaction. “Operating day” and “time” indicate operating day and time of sales. “Amount” is a sales amount for one transaction, obtained by “unit cost”×“quantity”.

“Latitude” and “longitude” are position data received and obtained by the GPS function in each parking area for mobile sales (position data indicating a venue where mobile sales are being conducted).

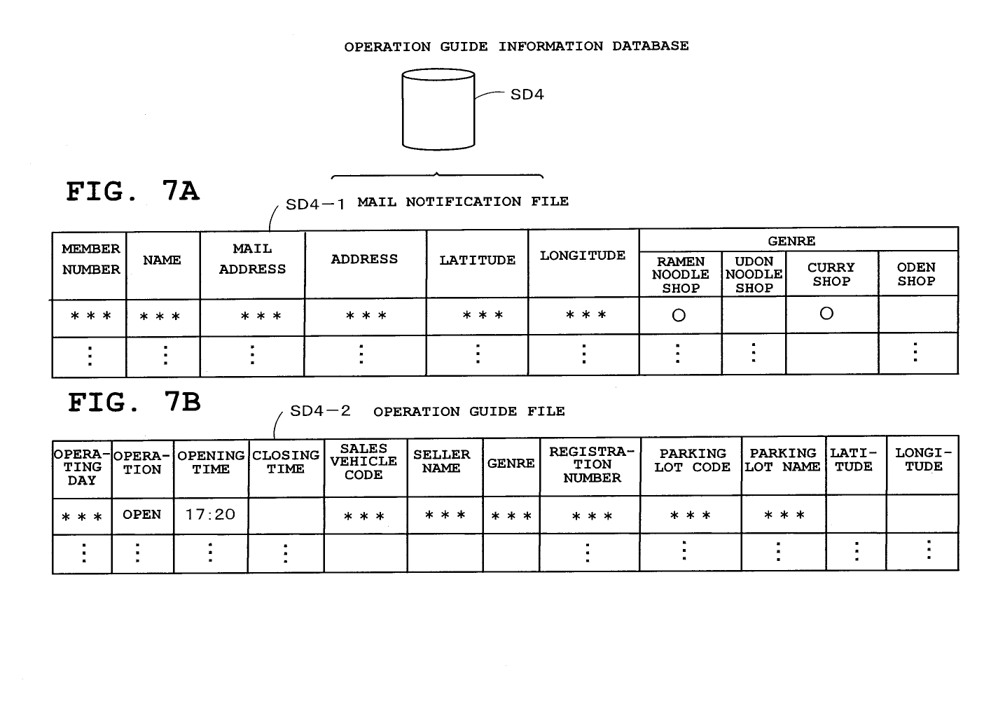

FIG. 7A and FIG. 7B are diagrams for describing the operation guide information database SD4 in the management server device 1.

The operation guide information database SD4 stores and manages, for the purpose of providing services of informing general member users of venues for mobile sales, data about the member users and data about the mobile sales, and has a mail notification file SD4-1 depicted in FIG. 7A and an operation guide file SD4-2 depicted in FIG. 7B.

The mail notification file SD4-1 is a file for use in informing and notifying the member users of the data about the mobile sales via electronic mail, and has items of “member number”, “name”, “mail address”, “address”, “latitude”, and “longitude” as data about the users registered by inputting items in a membership registration application and items of “ramen noodle shop”, . . . “oden shop” indicating genres desired to be informed.

“Latitude” and “longitude” indicate position data of “address” of each member which have been received and obtained from the cartographic information server device 4.

The operation guide file SD4-2 is a file for use in guiding the user to a Web (World Wide Web) page for mobile sales provided by a site operator operating a site for mobile sales using a parking lot. As depicted in FIG. 7B, the operation guide file SD4-2 has items of “operating day”, “operation, “opening time”, and “closing time” as data regarding operation of mobile sales, items of “sales vehicle code”, “seller name”, “genre”, and “registration number” as data regarding sales vehicles, and items of “parking lot code”, “parking lot name”, “latitude”, and “longitude” as data regarding parking lots. “Operation” is data indicating whether the shop is open or closed.

FIG. 8 is a diagram for describing the area analysis information database SD5 on the management server apparatus 1 side.

This area analysis information database SD5 stores and manages data required for mobile sales area analysis, and has a time-zone-based total sales file SD5-1.

The time-zone-based total sales file SD5-1 is a file for totalizing sales data by business hour zone (for example, for every one hour) set in advance on the system side when a mobile sales report is received from the sales terminal device 2, and storing and managing the totalized sales data, and has items of “operating day”, “day of week”, “time zone”, “parking lot code”, “parking lot name”, “latitude”, “longitude”, “sales vehicle code”, “seller name”, “genre”, and “total sales amount (tax included) “.

“Total sales amount (tax included)” represents a total amount (tax included) obtained by totalizing sales data by “operating day”, “day of week”, “time zone”, “parking lot code”, and “sales vehicle code”, and is a totalization result by business time zone (for example, for every one hour).

When a mobile sales proceeds analysis (area analysis) in a specified area is requested by the sales terminal device 2, the management server apparatus 1 analyzes totalization results in the area analysis information database SD5, generates screen data where the analysis results have been developed in a map of the specified area, and then transmits the screen data to the sales terminal device 2 of the requesting source.

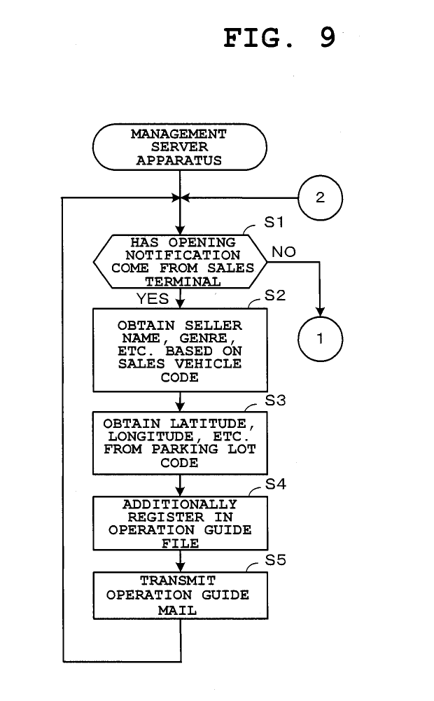

Next, the operation concept of the sales data processing system in the present embodiment is described with reference to flowcharts depicted in FIG. 9 to FIG. 11.

Here, each function described in the flowcharts is stored in a readable program code format, and operations based on these program codes are sequentially performed.

Also, operations based on the above-described program codes transmitted over a transmission medium such as a network can also be sequentially performed. That is, the unique operations of the present embodiment can be performed using programs and data supplied from an outside source over a transmission medium, in addition to a recording medium.

FIG. 9 to FIG. 11 are flowcharts outlining the operation of a characteristic portion of the present embodiment from among all of the operations of the management server device 1, which is started when power is turned ON, and performed between the management server device 1 and the sales terminal device 2 of the mobile seller.

First, an overview of operations of the sales terminal device 2 is briefly described. When an opening button (omitted in the drawings) for instructing to start (open) mobile sales is operated, an opening notification including the “sales vehicle code” of the sales terminal device 2 and the “parking lot code” of a parking lot desired for the mobile sales is provided to the management server apparatus 1.

Then, when a registration operation for inputting sales data is performed, the sales terminal device 2 performs processing for receiving and obtaining current position data (the location of a mobile sales parking area: sales location) from the GPS positioning section 25, associating the sales data and the position data with each other, and registering the associated data in a sales file (omitted in the drawings) of the sales management information database TD.

Then, after the business of the day is over and a closing button for instructing to close is operated, the sales terminal device 2 reads each sales data and position data from the opening time to the closing time from the sales file as details of a sales report, and transmits a closing notification including the sales vehicle code of the sales terminal device 2 and the parking lot code in use to the management server apparatus 1.

Also, when an operation for requesting a mobile sales area analysis is performed for sales strategies and the like, the sales terminal device 2 notifies the management server apparatus 1 of this analysis request. In response, when an input sheet for inputting analysis conditions is sent from the management server apparatus 1, the sales terminal device 2 causes the input sheet to be displayed.

In this state, when various analysis conditions are inputted and set in respective items of the input sheet, the sales terminal device 2 returns the inputted analysis conditions to the management server apparatus 1.

When the opening notification is received from the sales terminal device 2 (YES at Step S1 of FIG. 9), the CPU 11 of the management server apparatus 1 searches the sales vehicle file SD2-1 in the selling management information database SD2 based on the sales vehicle code included in this opening notification to read and obtain “seller name”, “genre”, and “registration number” (Step S2), and then searches the parking lot file SD1-1 in the parking lot information database SD1 based on the parking lot code included in this opening notification to read and obtain “parking lot name”, “latitude”, and “longitude” (Step S3).

Then, the CPU 11 sets the current day and time as a operating day and an opening time, generates an operation guide record with “sales vehicle code”, “seller name”, “genre”, “registration number”, “parking lot code”, “parking lot name”, “latitude”, and “longitude”, and additionally registers this generated record in the operation guide file SD4-2 in the information database SD4 (Step S4).

Then, the CPU 11 sends an operation guide for notification of new opening by e-mail to relevant member users (Step S5), and returns to Step S1 described above.

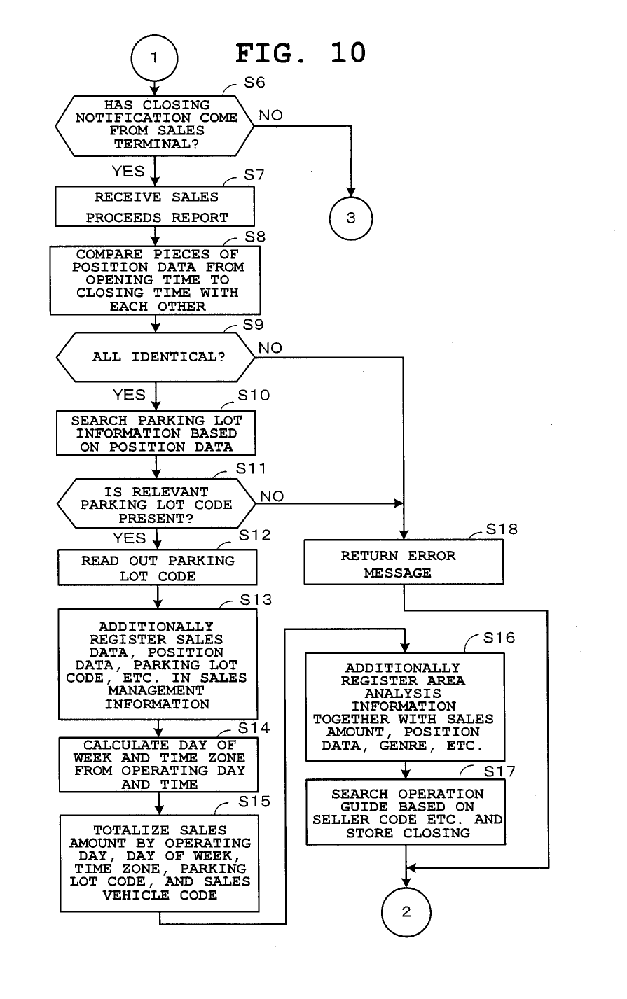

When a closing notification is received from the sales terminal device 2 (YES at Step S6 of FIG. 10), the CPU 11 of the management server apparatus 1 receives and obtains a sales report included in the closing notification (including each sales data and position data from the opening time to the closing time) (Step S7).

Then, the CPU 11 compares the pieces of position data from the opening time to the closing time with each other (Step S8) to check whether they are all identical position data (Step S9). When they are not identical position data (NO at Step S9), the CPU 11 generates an error message indicating this, and transmits the error message to the sales terminal device 2 (Step S18).

When these position data from the opening time to the closing time are identical (YES at Step S9), the CPU 11 searches the parking lot file SD1-1 in the parking lot information database SD1 based on the position data (Step S10) to check whether a relevant “parking lot code” has been stored (Step S11).

When a relevant “parking lot code” has not been stored (NO at Step S11), the CPU 11 generates an error message indicating this, and transmits the error message to the sales terminal device 2 (Step S18). When a relevant “parking lot code” has been stored, that is, when the parking lot can be identified (YES at Step S11), the CPU 11 reads out the “parking lot code” from the parking lot file SD1-1 (Step S12).

Next, the CPU 11 of the management server apparatus 1 additionally registers data of necessary items such as the sales report (including the seller code, the slip number, the operating day, time, and each sales data and position data from the opening time to the closing time) and the parking lot code in the sales file SD3-1 in the sales management information database SD3 (Step S13).

Then, the CPU 11 calculates a day of week and a time zone from the operating day and time (Step S14), and totalizes the sales amount (tax included) by operating day, day of week, time zone, parking lot code, and seller code (Step S15).

Then, the CPU 11 additionally registers the sales amount (tax included) together with the operating day, day of week, time zone, parking lot code, position data, genre, etc. in the time-zone-based total sales file SD5-1 in the area analysis information database SD5 (Step S16).

Then, the CPU 11 searches the operation guide file SD4-2 based on the parking lot code and the sales vehicle code, changes “operation” in the relevant record from “opening” to “closing”, and writes “closing time” (Step S17). Then, the CPU 11 returns to Step S1 of FIG. 9.

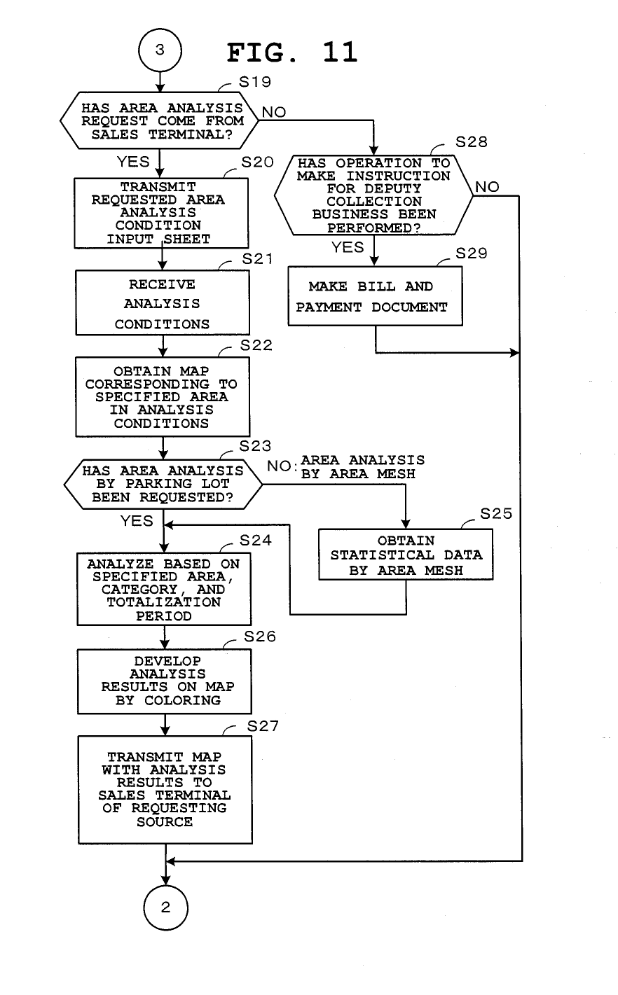

On the other hand, when an area analysis request is received from the sales terminal device 2 (YES at Step S19 of FIG. 11), the CPU 11 of the management server apparatus 1 transmits an area analysis condition input sheet of the requested type to the sales terminal device 2 of the requesting source (Step S20).

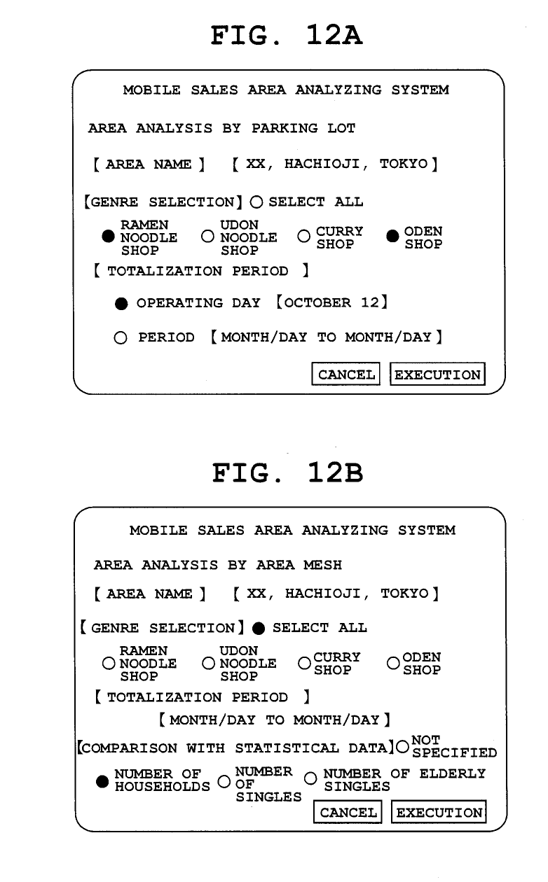

FIG. 12A and FIG. 12B are diagrams exemplarily depicting area analysis condition input sheets of two types. When requesting an area analysis, the sales terminal device 2 makes an area analysis request by specifying one of these types. If such a specification is not performed, the CPU 11 transmits the area analysis condition input sheets of two types to the sales terminal device 2 of the requesting source.

FIG. 12A depicts an input sheet for area analysis by parking lot which is used to request a sales proceeds analysis by parking lot present in a specified area.

As analysis condition input items, the input sheet has “area name” for specifying an area for which a sales proceeds analysis is requested, “genre selection” for selecting a product for which a sales proceeds analysis is requested, and “totalization period” for specifying a period for which a sales proceeds analysis is requested.

“Area name” is an input item for inputting address data, and “genre selection” is a selection item for selecting one of “select all”, “ramen noodle shop”, “udon noodle shop”, “curry shop”, and “oden shop”. “Totalization period” is an input item for selecting one of periods specified by arbitrarily specified “operating day” and “month/day to month/day” and for inputting period data in association with the operating day or period.

Note that, when “totalization period” is to be specified, not only “operating day” or “month/day to month/day” but also a time zone such as 17:00 to 19:00 may be specified as a totalization period, and any day of week may be specified as a totalization period.

Also, for example, Fridays in November to December or 18:00 to 21:00 in July to August may be specified as a totalization period, or Friday of the third week may be specified as a totalization period.

That is, a configuration may be adopted in which at least one of a date, time zone, month, day of week, or week is specified as a period.

FIG. 12B depicts an input sheet for area analysis by area mesh which is used to request a sales proceeds analysis by partition obtained by partitioning a specified area into meshes. As analysis condition input items, the input sheet has the above-described “area name”, “genre selection”, and “totalization period” as well as “comparison with statistical data”.

Area analysis by area mesh is an analysis method in which a specified area is partitioned into approximately square shapes like meshes such as reference area meshes of approximately 1 km squares or half area meshes (500 m meshes) based on latitude and longitude information, and sales data is totalized and analyzed by area mesh.

“Comparison with statistical data” is an item for specifying whether to request census area mesh statistical data, that is, area mesh statistical data (the number of households, the number of singles, and the number of elderly singles) obtained by partitioning a specified area in meshes (in a matrix), and is a selection item for selecting statistical data to be compared with sales data by partition.

In this case, an arbitrary item is selected from among “not specified”, “the number of households”, “the number of singles”, and “the number of elderly singles”, but any combination of these items may be selected.

In the area analysis condition input sheets depicted in FIG. 12A and FIG. 12B, a cancel button for cancelling an input and an execution button for confirming the input are provided as operation buttons. In the sales terminal device 2, when the execution button is operated after each analysis condition is inputted, the input details of the input sheet are transmitted to the management server apparatus 1.

When the analysis conditions are received from the sales terminal device 2 (Step S21 of FIG. 11), the CPU 11 of the management server apparatus 1 extracts a specified area from the analysis conditions, accesses the map information server apparatus 4, and obtains map data relevant to the specified area (Step S22).

Then, the CPU 11 judges whether an area analysis by parking lot depicted in FIG. 12A has been requested (Step S23). When judged that an area analysis by parking lot has been requested (YES at Step S23), the CPU 11 searches the time-zone-based total sales file SD5-1 in the area analysis information database SD5 according to the analysis conditions (the specified area, genre, and totalization period), performs an analysis according to the conditions (Step S24), and develops the analysis results in the map of the specified area by coloring (Step S26).

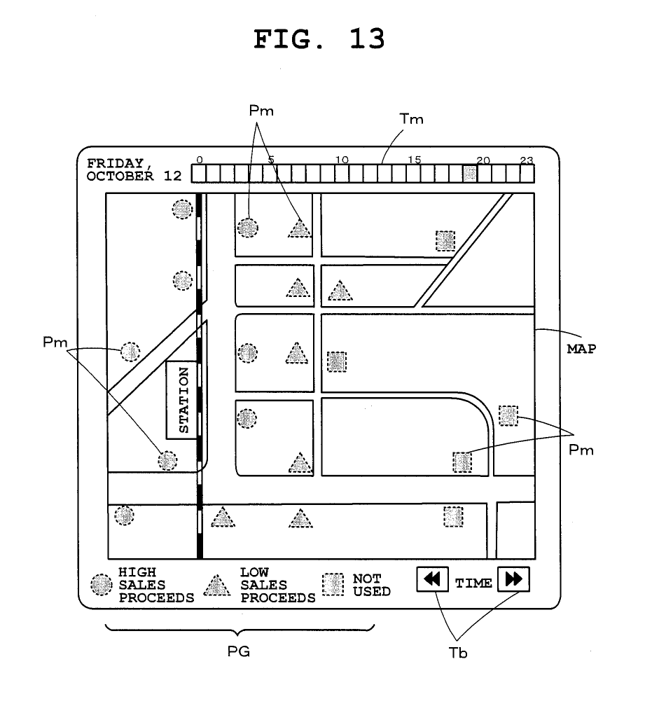

FIG. 13 is a diagram exemplarily depicting results (screen data) of area analysis by parking lot developed in a map of a specified area.

On the map of the arbitrarily specified area, parking lot marks Pm are placed corresponding to the positions of parking lots present in that specified area.

By the parking lots being classified into a plurality of ranks according to their sales amounts and colored for each of the plurality of sales proceeds analysis ranks, the parking lot marks Pm have different colors according to the sales amounts at the respective parking lots.

The parking lot marks Pm colored according to their sales proceeds analysis ranks are placed (mapped) at the positions of the relevant parking lots on the map so as to be identifiable.

In the margin of the map (on the lower side of the map), pieces of guide information PG for guiding the types of the parking lot marks Pm are placed.

A circular (red) guide information PG indicates a parking lot with high sales proceeds, a triangular (blue) guide information PG indicates a parking lot with low sales proceeds, and a square (yellow) guide information PG indicates a parking lot without sales proceeds, that is, a parking lot not used for mobile sales. In this case, judgments are made as classification of “high sales proceeds” or “low sales proceeds” based on an average value or deviation value of a total sales amount by parking lot or a specified judgment amount. The position of a parking lot where no mobile sales have been conducted is judged as “not used”. In the example depicted in the drawing, sales proceeds at parking lots near a station are large.

Also, as depicted in FIG. 13, time slide buttons (time forward buttons) Tb for forwarding a specified time zone by hour to right or left are placed in the margin of the map (the lower side of the map). In the drawing, a rightward-double-arrowed time slide button Tb is a button for right forwarding, and a leftward-double-arrowed time slide button Tb is a button for left forwarding.

Also, in the margin of the map (on the upper side of the map), a time axis area Tm is placed, in addition to an operating day (month and day) and day of week. This operating day, day of the week and the time axis area Tm clarify the time in which the sales proceeds analysis results are directed. In the example depicted in the drawing, sales proceeds analysis results for a period of time between 19:00 to 20:00 on Friday, October 12 have been exemplarily depicted.

This time axis area Tm is calibrated to display 0:00 to 23:00 by hours, and an arbitrary time zone can be specified. In the drawing, a hatched area indicates a specified time zone.

Every time the rightward-double-arrowed time slide button Tb is operated, the specified time zone is shifted to right in the drawing by the hour. Also, every time the leftward-double-arrowed time slide button Tb is operated, the specified time zone is shifted to left in the drawing. As a result, the analysis results in the map can be changed to analysis results corresponding to the specified time zone.

At Step S23, when an area analysis by area mesh is requested (NO at Step S23 of FIG. 11), the CPU 11 extracts “comparison with statistical data” from the analysis conditions, accesses the map information server apparatus 4, and obtains statistic data by mesh (Step S25).

In this case, based on the data of “comparison with statistical data”, the CPU 11 specifies at least one of the number of households, the number of singles, and the number of elderly singles as statistical data.

Then, the CPU 11 searches the time-zone-based total sales file SD5-1 in the area analysis information database SD5 according to the analysis conditions (the specified area, genre, and totalization period), performs an analysis according to the conditions (Step S24), and develops the analysis results in the map of the specified area by coloring (Step S26).

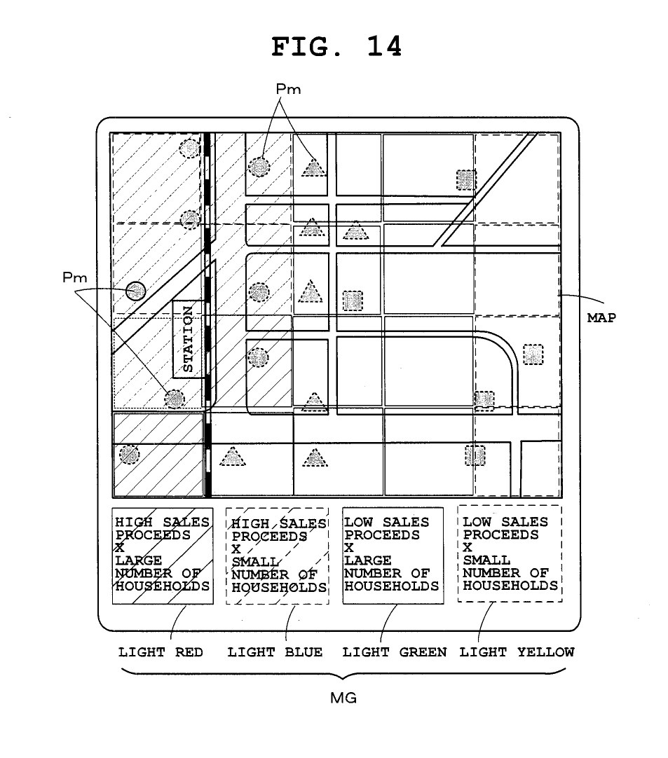

FIG. 14 is a diagram exemplarily depicting results (screen data) of area analysis by area mesh developed in a map of a specified area.

On the map of the specified area, as with the case of FIG. 13, the parking lot marks Pm are placed at the positions of parking lots present in the specified area. The parking lot marks Pm have different colors according to sales amounts at the respective parking lots.

On the map of the specified area where the parking lot marks Pm have been placed (mapped), meshes colored based on sales proceeds analysis ranks by mesh partition are superimposed.

That is, in the depicted example, the number of households has been specified as statistical data, combinations of a sales amount in a partition and the number of households have been classified into a plurality of ranks, such as “high sales proceeds×large number of households”, “high sales proceeds×small number of households”, “low sales proceeds×large number of households”, and “low sales proceeds×small number of households”, and the entire area of each partition is colored in different color by rank for the clarification of the plurality of ranks.

Here, the entire area of each section is translucently colored (colored in light color) so that the details of the map and the parking lot marks Pm can be checked (can be viewed).

In the margin of the map (the lower side of the map), guide information MG for guiding types of combination of a sales amount and statistical data is placed.

That is, in guide information MG for “high sales proceeds×large number of households”, a character string of “high sales proceeds×large number of households” is placed inside, and the entire information is colored in light red. In guide information MG for “high sales proceeds×small number of households”, a character string of “high sales proceeds×small number of households” is placed inside, and the entire information is colored in light blue.

In addition, in guide information MG for “low sales proceeds×large number of households”, a character string of “low sales proceeds×large number of households” is placed inside, and the entire information is colored in light green. In guide information MG for “low sales proceeds×small number of households”, a character string of “low sales proceeds×small number of households” is placed inside, and the entire information is colored in light yellow.

The CPU 11 of the management server apparatus 1 transmits, to the sales terminal device 2 of the requesting source, screen data generated by developing the analysis results on the map which have been obtained by analyzing the total sales according to the analysis conditions requested from the sales terminal device 2 as described above (Step S27). Then, the CPU 11 returns to Step S1 of FIG. 9.

Also, when it is detected that an operation to make an instruction for deputy collection business has been performed (YES at Step S28 of FIG. 11), the CPU 11 performs processing for creating a bill to the mobile seller and a payment document to the parking lot operator (Step S29), and then returns to Step S1 of FIG. 9.

Hereafter, until power-off, the CPU 11 performs operations of FIG. 9 to FIG. 11.

As described above, in the present embodiment, the management server apparatus 1 receives sales data and position data of a parking lot serving as a sales venue transmitted from the sales terminal device 2 placed on a mobile sales vehicle side, when sales are being conducted in the parking lot by the mobile sales vehicle, and totalizes sales data of mobile sales for each parking lot based on the sales data and the position data into the time-zone-based total sales file SD5-1 in the area analysis information database SD5. In addition, when an analysis condition is specified for analyzing the totalization results, the management server apparatus 1 analyzes the totalization results according to the analysis condition, and develops and outputs the analysis results on a map. Therefore, it is possible to help mobile sellers (mobile sales vehicles) find parking lots as sales venues, and it is also possible to plainly provide information contributing to high sales efficiency, whereby mobile sales can be promoted and effective use of parking lots as sales venues can be expected.

Also, when sales data and current position data are received from the sales terminal device 2 as a sales report for mobile sales, the management server apparatus 1 identifies a parking lot relevant to the position data, and totalizes the sales data as sales data obtained by sales at this parking lot. As a result of this configuration, the management server apparatus 1 can totalizes sales data after confirming that a sales report is obtained from mobile sale at an appropriate place.

Moreover, when an instruction to perform an analysis is given with a product genre of mobile sales as an analysis condition, the management server apparatus 1 analyzes totalization results by sales venue of the specified genre. As a result of this configuration, mobile sellers can obtain, for example, information regarding which genre of product have been sold well and at which place (parking lot) it has been sold well.

Furthermore, when an instruction to perform an analysis is given with a specified area as an analysis condition is given, the management server apparatus 1 identifies parking lots present in the specified area, analyzes totalization results by parking lot, and develops sales data by parking lot as the analysis results on a map of the specified area. As a result of this configuration, mobile sellers can obtain, for example, information regarding at which place (parking lot) products have been sold well in an area desired by the mobile sellers.

Still further, when an instruction to perform an analysis is given with a specified period as an analysis condition, the management server apparatus 1 analyzes totalization results in the specified period for each parking lot, and develops sales status by period for each parking lot on a map. As a result of this configuration, mobile sellers can obtain, for example, information regarding in which period products have been sold well even at the same parking lot.

Yet still further, totalization results in a period specified by an arbitrary month and day (date) or in an arbitrary specified day (operating day) serving as a specified period are analyzed. As a result of this configuration, mobile sellers can search for, for example, a business place (parking lot) with high sales efficiency based on a time zone in business hours in a day, and conduct mobile sales.

Yet still further, the management server apparatus 1 develops an analysis result at a position of a relevant parking lot on a map. As a result of this configuration, for mobile sellers, a correspondence between an analysis result and a parking lot is clear and therefore easy to understand visually.

Yet still further, when analyzing a totalization result for each parking lot in a specified period, the management server apparatus 1 classifies parking lots into a plurality of ranks according to sales amounts therein, and performs color classification on the plurality of ranks to develop colored ranks at positions of relevant parking lots on the map so that the ranks are identifiable. As a result of this configuration, mobile sellers can easily understand the ranks visually.

Yet still further, the time axis display area Tm allowing an arbitrary time zone to be specified is placed in the margin of a map. As a result of this configuration, mobile sellers can easily understand for which time zone analysis results are directed to currently, and operability is also enhanced.

Yet still further, when an instruction to perform an analysis is given with a specified area as an analysis condition, the management server apparatus 1 obtains statistical data regarding the specified area, identifies parking lots present in the specified area, analyzes totalization results by parking lot and the statistical data regarding the specified area, and develops the analysis result in a map of the specified area. As a result of this configuration, mobile sellers can know statistical data in a specified area, which serves as effective information in sales strategies.

Yet still further, the management server apparatus 1 analyses sales data and statistical data for each partition obtained by partitioning a specified area into meshes, and develops analysis results of sales data and statistical data of a corresponding partition in each partition obtained by partitioning a map of the specified area into meshes. As a result of this configuration, the following advantages are achieved with the use of area mesh statistics.

That is, in the area meshes, partitions are made in units of partitions of an approximately identical size and shape. Therefore, metrical comparison in phenomenon between area meshes can be easily made.

Also, since the positions and partitions of the area meshes are fixed, the area meshes are not influenced by a change of an area boundary between municipal administrative areas and the like or a setting change regarding an investigation area due to a geographic or planimetric change, and comparison between area phenomenons can be easily performed in time series.

Moreover, by summing up data of area meshes in an arbitrary area, required area data can be easily obtained.

Yet still further, for each partition obtained by partitioning a specified area into meshes, combinations of a sales amount and the number of households in the partition are classified into a plurality of ranks, and each entire partition is translucently colored to clarify these ranks. As a result of this configuration, various area analyses can be performed by comparing sales data by partition and area mesh statistical data.

For example, a sales amount totalized by area mesh is classified into high and low, classification is made from statistical data as to whether the number of households in that area mesh is large or small, and then coloring is made based on these two analysis items. As a result of this configuration, an area with a low sales amount and a large number of households can be visually known, and mobile sellers can easily find a parking lot permitted for mobile sales in that area.

In the above-described embodiment, when an area analysis is requested from the sales terminal device 2, the management server apparatus 1 performs the requested area analyses, generates screen data with the analysis results mapped on a map, and transmits the screen data to the sales terminal device 2. However, a configuration may be adopted in which, irrespective of the request from the sales terminal device 2, various area analyses are preformed in advance on the management server apparatus 1 side, and the area analysis results are published on a Web page (a Web page provided from a site operation business operator operating a mobile sales site).

Also, a configuration may be adopted in which area analysis results are transmitted directly to a mobile seller. In this case, the area analysis results are preferably transmitted in consideration of the genre, sales area, etc. of the mobile seller.

Moreover, in the above-described embodiment, when an area analysis by parking lot is performed, ranks of three types, that is, “high sales proceeds”, “low sales proceeds”, and “not used”, are identifiable, as depicted in FIG. 13. However, the present invention is not limited thereto, and ranks of four types or more may be identifiable.

Furthermore, ranking may be performed with reference to “large number of customers” and “small number of customers”. In addition, a configuration may be adopted in which information about gender, age bracket, etc. are received from the sales terminal device 2 as attributes of customers and stored and managed, whereby an analysis result according to the attributes of the customers can be obtained.

Still further, in the above-described embodiment, when an area analysis by area mesh is performed, meshes with colored sales proceeds analysis ranks by mesh partition are superimposed on the map of a specified area having the parking lot marks Pm mapped thereon, as depicted in FIG. 14. However, a configuration may be adopted in which only meshes with colored sales proceeds analysis ranks are developed on a map.

Yet still further, in the above-described embodiment, coloring is exemplarily described as means for identifying ranks in area analysis by parking lot and area analyses by area mesh. However, means such as shape, pattern, concentration, or flashing/lighting may be used for this identification.

Yet still further, in the above-described embodiment, screen data with analysis results developed on a map is generated. However, the present invention is not limited thereto, and print data may be generated.

Yet still further, the “devices” or the “sections” described in the above-described embodiment are not required to be in a single housing and may be separated into a plurality of housings by function.

In addition, the steps in the above-described flowcharts are not required to be processed in time-series and may be processed in parallel or individually and independently.

Yet still further, in the above-described embodiment, parking lots are described as examples of sales venues. However, the sales venues are not limited to parking lots, and may be places within the premises of a large supermarket, public spaces such as plazas or parks, vacant lots, or places on a road.

While the present invention has been described with reference to the preferred embodiments, it is intended that the invention be not limited by any of the details of the description therein but includes all the embodiments which fall within the scope of the appended claims.

1. A sales management apparatus which manages sales data transmitted from a sales terminal device via a communication network, comprising:
a receiving section which receives sales data and position data of a sales venue transmitted from the sales terminal device placed on a mobile sales vehicle side, when sales are being conducted at the sales venue by the mobile sales vehicle;
a totalizing section which totalizes the sales data by mobile sales for each sales venue based on the sales data and the position data received by the receiving section;
an analyzing section which, when an analysis condition for analyzing totalization results obtained by the totalizing section is specified, analyzes the totalization results obtained by the totalizing section according to the analysis condition; and
an output section which develops and outputs analysis results obtained by the analyzing section on a map.

2. The sales management apparatus according to claim 1, further comprising:
a storage section which stores and manages the position data for each sales venue where mobile sales by a mobile sales vehicle is permitted under contracts with an operator operating business of renting the sales venue by hour; and
a searching section which identifies a sales venue relevant to the position data by searching the storage section based on the position data received with the sales data by the receiving section,
wherein the totalizing section totalizes the sales data received by the receiving section as sales data obtained by sales at the sales venue, when the sales venue is identified by the searching section.

3. The sales management apparatus according to claim 1, wherein the analyzing section analyzes, when an instruction for an analysis is given with a product genre of mobile sales as an analysis condition, totalization results by sales venue of the specified genre.

4. The sales management apparatus according to claim 1, wherein the analyzing section identifies, when an instruction for an analysis is given with a specified area as an analysis condition, sales venues present in the specified area, and analyzes totalization results by sales venue, and
wherein the output section develops and outputs sales data by sales venue on a map of the specified area, as the analysis results obtained by the analyzing section.

5. The sales management apparatus according to claim 1, wherein the receiving section receives an operating day and time for mobile sales together with the sales data and the position data transmitted from the sales terminal device,
wherein the totalizing section totalizes the sales data of mobile sales by operating day and time for each sales venue based on the sales data, the position data, and the operating day and time for mobile sales received by the receiving section, and
wherein the analyzing section analyzes, when an instruction for an analysis is given with a specified period as an analysis condition, totalization results in the specified period for each sales venue.

6. The sales management apparatus according to claim 5, wherein the analyzing section analyzes, when an instruction for an analysis is given with at least one of a date, a month, a week, a time zone, and a day of week as the specified period, totalization results in the specified period.

7. The sales management apparatus according to claim 5, wherein the output section develops the analysis results obtained by the analyzing section at a position of a relevant sales venue on the map.

8. The sales management apparatus according to claim 7, wherein the analyzing section classifies sales venues into a plurality of ranks according to sales status, when analyzing the totalization results for each sales venue in the specified period, and
wherein the output section develops the plurality of ranks obtained from classification by the analyzing section at positions of relevant sales venues on the map such that the plurality of ranks are identifiable.

9. The sales management apparatus according to claim 5, wherein the output section arranges, on the map or a margin of the map, a time axis area which allows an arbitrary time zone to be specified.

10. The sales management apparatus according to claim 1, wherein the analyzing section includes an obtaining section which obtains, when an instruction for an analysis is given with a specified area as an analysis condition, statistical data regarding the specified area,
wherein the analyzing section identifies sales venues present in the specified area, analyzes totalization results by sales venue, and analyzes statistical data regarding the specified area, and
wherein the output section develops and outputs the analysis results obtained by the analyzing section on a map of the specified area.

11. The sales management apparatus according to claim 10, wherein the analyzing section analyzes the sales data and the statistical data for each partition obtained by partitioning the specified area into meshes, and
the output section develops and outputs, on each partition obtained by partitioning the map of the specified area into meshes, analysis results of the sales data and the statistical data of a corresponding partition.

12. The sales management apparatus according to claim 11, wherein the analyzing section classifies combinations of the sales data and the statistical data into a plurality of ranks when analyzing the sales data and the statistical data for each partition obtained by partitioning the specified area into meshes, and
the output section develops the plurality of ranks obtained from classification by the analyzing section in relevant partitions on the map partitioned into meshes such that the plurality of ranks are identifiable.

13. A non-transitory computer-readable storage medium having stored thereon a program that is executable by a computer, the program being executable by the computer to perform functions comprising:
processing for receiving, via a communication network, sales data and position data of a sales venue transmitted from a sales terminal device placed on a mobile sales vehicle side when sales are being conducted at the sales venue by the mobile sales vehicle;
processing for totalizing the sales data by mobile sales for each sales venue based on the received sales data and position data;
processing for analyzing totalization results according to an analysis condition for analyzing the totalization results; and
processing for developing and outputting analysis results on a map.
